(19) United States
(12) Patent Application Publication
(10) Pub. No.: US 2010/0287276 A1
(43) Pub. Date: Nov. 11, 2010

(54) NETWORK DEVICE AND NETWORK DATA ACCESS RECORDER

(75) Inventor: HSIN-YAO HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/701,702

(22) Filed: Feb. 8, 2010

(30) Foreign Application Priority Data
May 8, 2009 (CN) 200910302182.7

(51) Int. Cl. G06F 15/16; G06F 12/00; G06F 12/16; G06F 15/173

(52) U.S. Cl. 709/224; 711/103; 711/104; 711/E12.001; 711/162; 711/E12.103; 709/223; 711/E12.008

(57) ABSTRACT

A network device includes flash memory to store a plurality of bits indicating login data on a user device. The network device sets the plurality of bits stored in the flash memory to a first value, sets a changing interval, and copies the plurality of bits from the flash memory to random access memory (RAM). The network device further searches for a first bit of the first value from the plurality of bits in the RAM, and records an index of the first bit of the first value in a variable. The network device further changes the first bit corresponding to the variable to a second value and increases the variable by 1 when the changing interval arrives. The network device further writes the bit changed to the second value from the RAM to the flash memory.

### BACKGROUND

1. Technical Field

Embodiments of the present disclosure relate to network communications, and more particularly to a network device and a method for recording login data on a user device.

2. Description of Related Art

Generally, a user device must lease a line from an Internet service provider (ISP) if the user device wants access to the Internet. Leased cost of the user device is often calculated by network access information (login data) on the user device, such as network access time (login time) and network access traffic of the user device.

The user device is often connected to the Internet via a network device such as a router. Therefore, a client-based login data recording device manageable by the ISP is desired.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is a schematic diagram of functional modules of one embodiment of a network device in accordance with the present disclosure;

FIG. 2 is a schematic diagram showing the network device of FIG. 1 recording network access time (login time) of a user device in accordance with one embodiment of the present disclosure;

FIG. 3 is a schematic diagram showing the network device of FIG. 1 recording network access traffic of a user device in accordance with one embodiment of the present disclosure;

FIG. 4 is a flowchart of one embodiment of a method for the network device of FIG. 1 managing login data on a user device in accordance with the present disclosure; and

FIG. 5 is a flowchart of one embodiment of a method for recording login data in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Alternatively, some or all of the methods may be embodied in specialized computer hardware or communication apparatus.

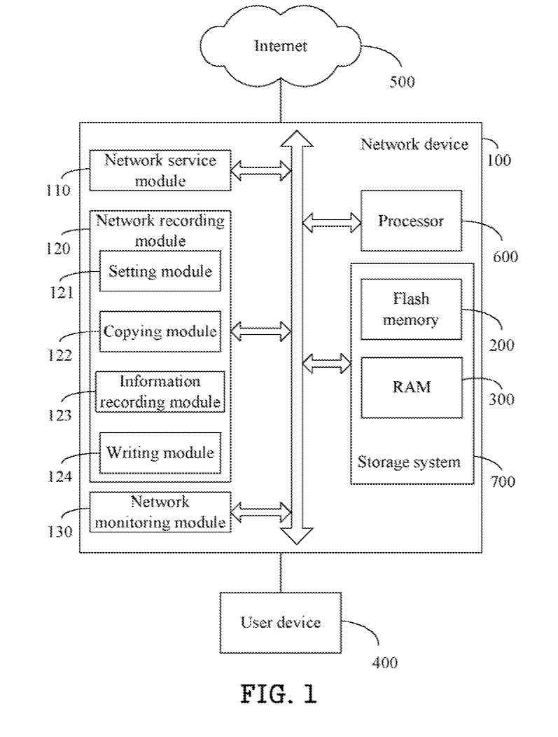

FIG. 1 is a schematic diagram of functional modules of one embodiment of a network device 100 in accordance with the present disclosure. In one embodiment, the network device 100 is connected between a user device 400 and the Internet 500, and operable to provide network access service for the user device 400. The network device 100 may be a network device that can be connected to the Internet 500, such as an xDSL/cable modem, a gateway, or a router. The user device 400 may be an electronic device that can access the Internet 500, such as a personal computer (PC), a notebook computer, or a personal digital assistant (PDA).

The network device 100 records login data on the user device 400. In one embodiment, the login data on the user device 400 includes network access time (login time) or network access traffic of the user device 400.

The network device 100 includes a network service module 110, a network recording module 120, a network monitoring module 130, at least one processor 600, and a storage system 700. The storage system 700 includes a flash memory 200 and a random access memory (RAM) 300. The network recording module 120 includes a setting module 121, a copying module 122, an information recording module 123, and a writing module 124. The modules 110, 121, 122, 123, 124, 130 may comprise one or more computerized instructions which may be in the storage system 700 and executed by at least one processor 600. Further description of the modules 110, 121, 122, 123, 124, 130 in conjunction with the network device 100 follows hereinafter.

The network service module 110 is operable to provide network access service for the user device 400. The network recording module 120 records login data (network access information) on the user device 400 by the flash memory 200. In one example, the login data (the network access information) includes network access time, where the network recording module 120 records information of how long a user of the user device 400 accesses the Internet 500 (e.g., 1 hour). In another example, the login data (the network access information) includes network access traffic, where the network recording module 120 records the amount of data (e.g., 1 KB) sent and received from the user device 400 to the Internet 500.

The RAM 300 is operable to temporarily store dynamic data to enhance performance of the network device 100. The flash memory 200 is operable to store a plurality of bits indicating login data on the user device 400. The plurality of bits corresponds to a plurality of indexes. In one embodiment, the flash memory 200 reserves a fixed block such as 64 KB, for storing the plurality of bits indicating the login data on the user device 400.

The setting module 121 is operable to set the plurality of bits which indicate the login data stored in the flash memory 200, to a first value. The setting module 121 is further operable to set a changing interval, where the changing interval is used to change the bits with the first value to a second value one by one. In one embodiment, the bits with the second value indicate login data on the user device 400 that has been recorded by the flash memory 200, and the bits with the first value indicate remaining login data that can be recorded by the flash memory 200. In one example, the first value is 1, and the second value is 0.

In one embodiment, the login data on the user device 400 includes network access time of the user device 400, where the changing interval is based according to the network access time of the user device 400. In another embodiment, the login data on the user device 400 includes network access traffic of the user device 400, where the changing interval is based according to the network access traffic of the user device 400.

The copying module 122 is operable to copy the plurality of bits indicating the login data from the flash memory 200 to the RAM 300 when the user device 400 starts to access the Internet 500 via the network device 100.

The information recording module 123 is operable to search for a first bit of the first value from the plurality of bits in the RAM 300, and record the index of the first bit of the first value in a variable. The information recording module 123 is further operable to change the first bit corresponding to the variable to the second value, and increase the variable by 1 when the changing interval arrives. The first bit changed to the second value is operable to indicate updated login data on the user device 400.

The writing module 124 is operable to determine whether all of the bits with the first value have been changed to the second value, and write the bit changed by the information recording module 123 from the RAM 300 to the flash memory 200 when not all of the bits with first value have been changed to the second value.

The network monitoring module 130 is operable to predefine a network access threshold of the user device 400, and determine whether the login data on the user device 400 in the flash memory 200 achieves the network access threshold of the user device 400. It should be understood that the network access threshold is a network access traffic or time close to and smaller than maximum network access traffic or time that the user device 400 can access the Internet 500. The network-monitoring module 130 is further operable to give an alarm when the login data on the user device 400 in the flash memory 200 achieves the network access threshold of the user device 400.

In one embodiment, the login data on the user device 400 may include network access time of the user device 400. For example, a user of the user device 400 orders 12 hours of network access time, that is, the user device 400 can only access the Internet 500 for 12 hours. Accordingly, the network access threshold of the user device 400 may be 11 hours. The network monitoring module 130 triggers an alarm when the network access time (login time) of the user device 400 reaches 11 hours. The network monitoring module 130 further suspends network access service to the user device 400 when the network access time (login time) equals 12 hours. That is, the network monitoring module 130 disables connectivity between the user device 400 and the Internet 500.

In another embodiment, the login data on the user device 400 may include network access traffic of the user device 400. For example, a user of the user device 400 orders 12 KB of network access traffic, and the network access threshold of the user device 400 is 11 KB of network access traffic. The network monitoring module 130 triggers an alarm when the login data of the user device 400 reaches 11 KB, and the network monitoring module 130 further suspends network access service for the user device 400 when the network access traffic of the user device 400 equals 12 KB.

In one embodiment, the alarm may include flashing of a light-emitting diode (LED). In another embodiment, the alarm trigger may be a system-generated dialog box/notice displayed on user device 400.

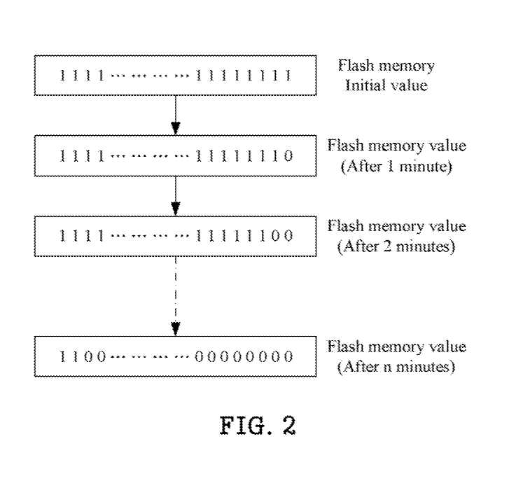

FIG. 2 is a schematic diagram showing the network device 100 of FIG. 1 recording network access time of the user device 400. In this embodiment, the login data on the user device 400 is the network access time of the user device 400. The setting module 121 sets each of the plurality of bits indicating the network access time of the user device 400 in the flash memory 200 to 1 (the first value), when the network device 100 starts to provide network access service for the user device 400.

The copying module 122 copies the plurality of bits indicating network access time from the flash memory 200 to the RAM 300 when the user device 400 accesses the Internet 500 via the network device 100 for the first time. The setting module 121 sets a changing interval to 1 minute. The information recording module 123 searches for a first bit of 1 (the first value) from the plurality of bits in the RAM 300, and records an index of the searched first bit in variable n. Here, the plurality of bits in the RAM 300 are all 1 (the first value), so the index of the searched first bit is 1. That is, variable n is equal to 1.

When 1 minute of the changing interval arrives, that is, the user device 400 has accessed the Internet 500 via the network device 100 for 1 minute, the information recording module 123 changes the first bit corresponding to variable n (n=1) to 0 (the second value), and increases variable n by 1. In other words, the information recording module 123 changes the first bit of 1 (the first value) in the RAM 300 to 0 (the second value), and adds variable n (n=1) by 1 to get new variable n (n=2). The changed first bit is operable to indicate updated network access time (login time).

Subsequently, the writing module 124 determines whether all the bits with the first value have been changed to the second value, and writes the first bit changed to the second value from the RAM 300 to the flash memory 200 when not all the bits with the first value have been changed to the second value. Referring to FIG. 2, here the first bit in the flash memory 200 is 0 (the second value), and the other bits are all 1 (the first value).

When 1 minute of the changing interval arrives again, that is, the user device 400 has accessed the Internet 500 via the network device 100 for 2 minutes, the information recording module 123 changes the bit corresponding to the variable n (n=2) to 0 (the second value), and increases variable n by 1. In other words, the information recording module 123 changes the second bit of 1 (the first value) in the RAM 300 to 0 (the second value), and adds variable n (n=2) by 1 to get new variable n (n=3). The current changed bit is also operable to indicate updated network access time (login time).

Subsequently, the writing module 124 determines whether all the bits with the first value have been changed to the second value, and writes the current changed bit from the RAM 300 to the flash memory 200 when not all of the bits with the first value have been changed to the second value. Referring to FIG. 2, here the first and second bits in the flash memory 200 are both 0 (the second value), and the other bits are all 1 (the first value).

By analogy, the bits from the first to the nₜₕ in the flash memory 200 are all 0 (the second value), and the other bits are all 1 (the first value), after the user device 400 has accessed the Internet 500 via the network device 100 for n minutes.

Therefore, the plurality of bits in the flash memory 200 reliably records the network access time of the user device 400.

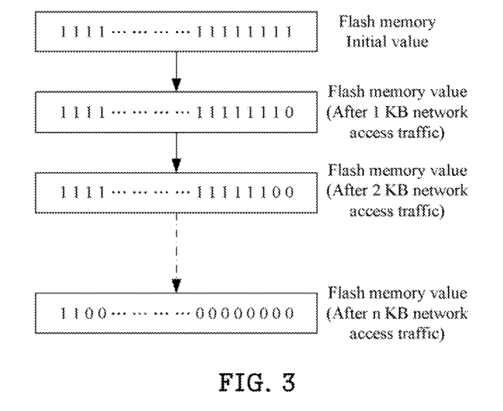

FIG. 3 is a schematic diagram showing the network device 100 of FIG. 1 recording network access traffic of the user device 400. In this embodiment, the login data on the user device 400 is the network access traffic of the user device 400. The setting module 121 sets each of the plurality of bits indicating the network access traffic of the user device 400 in the flash memory 200 to 1 (the first value), when the network device 100 starts to provide network access service to the user device 400.

The copying module 122 copies the plurality of bits indicating the network access traffic from the flash memory 200 to the RAM 300 when the user device 400 accesses the Internet 500 via the network device 100 for the first time. The setting module 121 sets a changing interval to 1 KB. The information recording module 123 searches for a first bit of 1 (the first value) from the plurality of bits in the RAM 300, and records an index of the searched first bit in variable n. Here, the plurality of bits in the RAM 300 are all 1 (the first value), so the index of the searched first bit is 1. That is, variable n is equal to 1.

When, 1 KB of the changing interval arrives, that is, network access traffic of the user device 400 has achieved 1 KB, the information recording module 123 changes the first bit corresponding to variable n (n=1) to 0 (the second value), and increases variable n by 1. In other words, the information recording module 123 changes the first bit of 1 (the first value) in the RAM 300 to 0 (the second value), and adds variable n (n=1) by 1 to get new variable n (n=2). The changed first bit is operable to indicate updated network accessed traffic.

Subsequently, the writing module 124 determines whether all of the bits with the first value have been changed to the second value, and writes the changed first bit from the RAM 300 to the flash memory 200 when not all of the bits with the first value have been changed to the second value. Referring to FIG. 3, here the first bit in the flash memory 200 is 0 (the second value), and the other bits are all 1 (the first value).

When, 1 KB of the changing interval arrives again, that is, the network access traffic of the user device 400 has achieved 2 KB. In such a case, the information recording module 123 changes the bit corresponding to the variable n (n32 2) to 0 (the second value), and increases variable n by 1. In other words, the information recording module 123 changes the second bit of 1 (the first value) in the RAM 300 to 0 (the second value), and adds variable n (n=2) by 1 to get new variable n (n=3). The current changed bit is also operable to indicate updated network accessed traffic.

Subsequently, the writing module 124 determines whether all of the bits with the first value have been changed to the second value, and writes the current changed bit from the RAM 300 to the flash memory 200 when not all of the bits with the first value have been changed to the second value. Referring to FIG. 3, here the first and second bits in the flash memory 200 are both 0 (the second value), and the other bits are all 1 (the first value).

By analogy, the bits from the first to the nₜₕ in the flash memory 200 are all 0 (the second value), and the other bits are all 1 (the first value), when the network access traffic of the user device 400 has achieved n KB.

Therefore, the plurality of bits in the flash memory 200 reliably records the network access traffic of the user device 400.

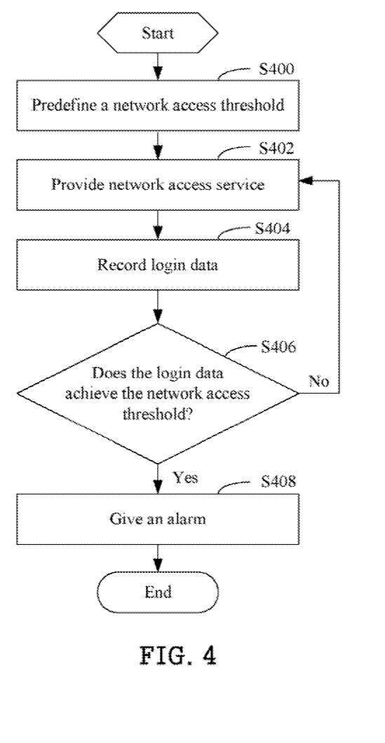

FIG. 4 is a flowchart of one embodiment of a method for the network device of FIG. 1 managing login data on the user device 400 in accordance with the present disclosure. Depending on the embodiment, additional blocks may be added, others may be deleted, and the ordering of the blocks may be changed.

In block S400, the network monitoring module 130 predefines a network access threshold of the user device 400.

In block S402, the network service module 110 provides network access service for the user device 400.

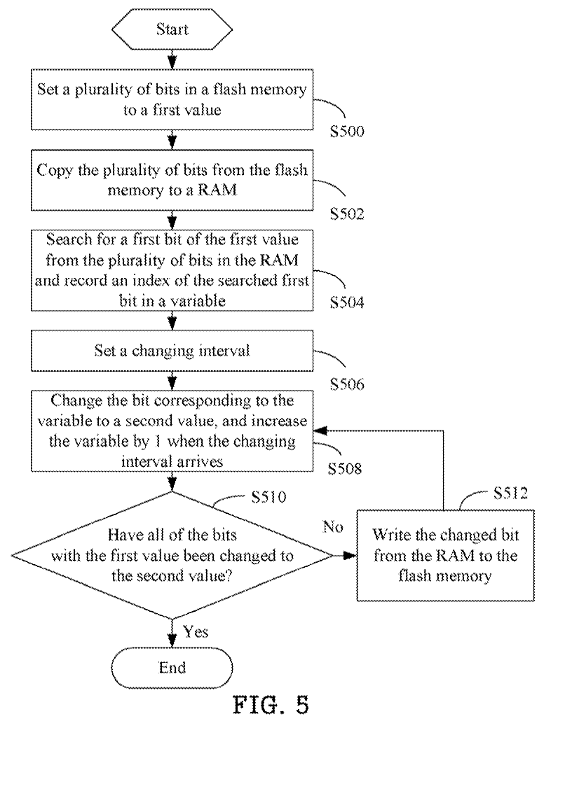

In block S404, the network recording module 120 records login data on the user device 400. Further description of block S404 will be explained in FIG. 5.

In block S406, the network monitoring module 130 determines whether the login data on the user device 400 in the flash memory 200 achieves the network access threshold of the user device 400.

If the login data on the user device 400 in the flash memory 200 does not achieve the network access threshold of the user device 400, going back to block S402, the network service module 110 provides network access service for the user device 400.

If the login data on the user device 400 in the flash memory 200 achieves the network access threshold of the user device 400, in block S408, the monitoring module 130 gives an alarm.

FIG. 5 is a flowchart of one embodiment of a method for recording login data in accordance with the present disclosure. The method is executed by the functional modules of FIG. 1. Depending on the embodiment, additional blocks may be added, others deleted, and the ordering of blocks may be changed while remaining well within the scope of the disclosure.

In block S500, the setting module 121 sets a plurality of bits stored in the flash memory 200 to a first value. In one embodiment, the plurality of bits in the flash memory 200 indicates login data on the user device 400.

In block S502, the copying module 122 copies the plurality of bits from the flash memory 200 to the RAM 300 when the user device 400 starts to access the Internet 500.

In block S504, the information recording module 123 searches for a first bit of the first value from the plurality of bits in the RAM 300, and records an index of the first bit of the first value in variable n.

In block S506, the setting module 121 sets a changing interval to change the bits with the first value to a second value one by one. In one embodiment, the first value is 1, and the second value is 0.

In one embodiment, the login data on the user device 400 includes network access time of the user device 400, and accordingly the changing interval is based according to the network access time of the user device. In another embodiment, the login data on the user device 400 includes network access traffic of the user device 400, and accordingly the changing interval is based according to the network access traffic of the user device 400.

In step S508, the information recording module 123 changes the bit corresponding to variable n to a second value, and increases variable n by 1 when the changing interval arrives. In one embodiment, the changed bit is operable to indicate updated login data on the user device 400.

In block S510, the writing module 124 determines whether all of the bits with the first value have been changed to the second value.

If not all of the bits with the first value have been changed to the second value, in block S512, the writing module 124 writes the changed bit from the RAM 300 to the flash memory 200.

The blocks S508-512 are loop-executed during the user device 400 accessing the Internet 500, until all of the bits with the first value have been changed to the second value or the user device 400 stops accessing the Internet 500.

In the present disclosure, the writing module 124 only writes the changed bit indicating updated login data on the user device 400 from the RAM 300 to the flash memory 200. That is, the flash memory 200 only has writing actions, but does not have erasing actions. Therefore, the flash memory 200 can reliably record the login data on the user device 400 in despite of interruption of power supply. Additionally, the copying module 122 and the writing module 124 perform copy/write functions on the flash memory 200 by bits to ensure efficient storage space usage by the flash memory 200.

While various embodiments of the present disclosure have been described above, it should be understood that they have been presented using example only and not using limitation. Thus the breadth and scope of the present disclosure should not be limited by the above-described embodiments, but should be defined only in accordance with the following claims and their equivalents.

What is claimed is:

1. A network device, comprising:
flash memory operable to store a plurality of bits indicating login data on a user device, the plurality of bits corresponding to a plurality of indexes to positions of the bits;
random access memory (RAM);
a setting module operable to set each of the plurality of bits stored in the flash memory to a first value, and operable to set a changing interval to change the bits with the first value to a second value one by one, wherein the bits with the second value indicate login data on the user device, and the bits with the first value indicate remaining login data on the user device;
a copying module operable to copy the plurality of bits from the flash memory to the RAM when the user device starts to access the Internet via the network device;
an information recording module operable to search a first bit of the first value from the plurality of bits in the RAM, and record an index of the first bit of the first value in a variable, and operable to change the first bit corresponding to the variable to the second value, and increase the variable by 1 when the changing interval arrives;
a writing module operable to determine whether all of the bits with the first value have been changed to the second value, and write the first bit changed by the information recording module from the RAM to the flash memory when not all of the bits with the first value have been changed to the second value; and
at least one processor operable to execute the setting module, the copying module, the information recording module, and the writing module.

2. The network device as claimed in claim 1, wherein the first value and the second value are 1 and 0, respectively.

3. The network device as claimed in claim 1, wherein the login data on the user device comprises network access time of the user device.

4. The network device as claimed in claim 3, wherein the changing interval is based according to the network access time of the user device.

5. The network device as claimed in claim 1, wherein the network device of the user device comprises network access traffic of the user device.

6. The network device as claimed in claim 5, wherein the changing interval is based on the network access traffic of the user device.

7. The network device as claimed in claim 1, further comprising a network service module operable to provide network access service for the user device.

8. The network device as claimed in claim 7, further comprising a network monitoring module operable to predefine a network access threshold of the user device, determine whether the login data on the user device in the flash memory achieves the network access threshold of the user device, and give an alarm when the login data on the user device achieves the network access threshold of the user device.

9. A method for recording login data on a user device, comprising:
providing flash memory and random access memory (RAM), wherein the flash memory is operable to store a plurality of bits indicating login data on the user device, the plurality of bits corresponding to a plurality of indexes to positions of the bits;
setting the plurality of bits stored in the flash memory to a first value;
copying the plurality of bits from the flash memory to the RAM when the user device starts to access the Internet;
setting a changing interval to change the bits with the first value to a second value one by one, wherein the bits with the second value indicate login data on the user device, and the bits with the first value indicate remaining login data on the user device;
searching for a first bit of the first value from the plurality of bits in the RAM and recording an index of the first bit of the first value in a variable;
changing the first bit corresponding to the variable to the second value and increasing the variable by 1 when the changing interval arrives;
determining whether all the bits with the first value have been changed to the second value; and
writing the bit changed to the second value from the RAM to the flash memory if not all the bits with the first value have been changed to the second value.

10. The method as claimed in claim 9, wherein the first value and the second value are 1 and 0, respectively.

11. The method as claimed in claim 9, wherein the login data on the user device comprises network access time of the user device.

12. The method as claimed in claim 11, wherein the changing interval is based according to the network access time of the user device.

13. The method as claimed in claim 9, wherein the network device of the user device comprises network access traffic of the user device.

14. The method as claimed in claim 13, wherein the changing interval is based according to the network access traffic of the user device.

15. The method as claimed in claim 9, further comprising:
predefining a network access threshold of the user device;
providing network access service for the user device;
determining whether the login data on the user device in the flash memory achieves the network access threshold of the user device; and
giving an alarm when the login data on the user device in the flash memory achieves the network access threshold of the user device.
